(19) United States
(12) Patent Application Publication
(10) Pub. No.: US 2007/0152500 A1
(43) Pub. Date: Jul. 5, 2007

(54) Brake control apparatus and method for controlling the brake

(75) Inventors: Katsuhiko Wakabayashi, Kanagawa (JP); Toshiyuki Innami, Ibaraki (JP); Hitoshi Kobayashi, Tokyo (JP); Akihiro Sato, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/648,568

(22) Filed: Jan. 3, 2007

(30) Foreign Application Priority Data
Jan. 5, 2006 (JP) 2006-000304

(51) Int. Cl. B60T 8/60

(52) U.S. Cl. 303/155; 303/DIG. 9

(57) ABSTRACT

A brake control apparatus includes a master cylinder, a wheel cylinder that is provided for a vehicle wheel, a hydraulic actuator that is provided separately from the master cylinder and adjusts a hydraulic pressure of the wheel cylinder, a control unit that controls the hydraulic actuator on the basis of a brake operating amount by a driver. The control unit has a main unit that performs the computation of a target hydraulic pressure of the wheel cylinder and a sub unit that drives the hydraulic actuator based on the target hydraulic pressure computed by the main unit.

### BACKGROUND OF THE INVENTION

The present invention relates to a brake control apparatus that obtains a braking force by controlling hydraulic pressure of a wheel cylinder, and more particularly to a brake control apparatus that carries out a brake-by-wire control.

In recent years, there have been proposed and developed various brake control apparatus, such as a brake control apparatus by using a brake-by-wire control. One such brake control apparatus has been disclosed in Japanese Patent Provisional Publication No. 2002-187537 (hereinafter is referred to as “JP2002-187537”). In the brake control apparatus disclosed in JP2002-187537, a hydraulic connection between a brake pedal and a wheel cylinder is separated, and a target wheel cylinder pressure is calculated on the bases of detected signal data by a stroke sensor and a master cylinder pressure sensor. Then, by driving a motor that connects to a pump, and an electromagnetic valve according to the calculated target wheel cylinder pressure, a desired wheel cylinder pressure to control the brake can be obtained.

### SUMMARY OF THE INVENTION

In the above brake control apparatus of JP2002-187537, however, the calculation or operation of the target wheel cylinder pressure and other operation of vehicle movement or stability control systems (ABS, VDC) etc. are executed by one control unit. For this reason, in a case where the brake control is carried out based on a coordinated control with other control units by means of CAN communication, the target wheel cylinder pressure is output only after the CAN communication and the operation of the other control units are completed. Thus, if communication speed and operation speed (computing speed) of the other control units are slow, there arises a problem that the brake control might also be delayed.

During a normal brake operation, in particular, a precise brake control according to or corresponding to a depression amount (operating amount) of a brake pedal is required. Therefore, if the brake control is delayed during the normal brake operation, a driver feels an awkward brake due to the delay of the brake.

It is therefore an object of the present invention to provide a brake control apparatus that is capable of securing a response of the brake control, even in the case where the communication speed and the operation speed of the other control units are slow.

According to one aspect of the present invention, a brake control apparatus comprises: a master cylinder; a wheel cylinder provided for a vehicle wheel; a hydraulic actuator provided separately from the master cylinder and adjusting a hydraulic pressure of the wheel cylinder; a control unit controlling the hydraulic actuator on the basis of a brake operating amount by a driver; and the control unit has a main unit that performs the computation of a target hydraulic pressure of the wheel cylinder and a sub unit that drives the hydraulic actuator based on the target hydraulic pressure computed by the main unit.

According to another aspect of the invention, a brake control apparatus comprises: a wheel cylinder provided for a vehicle wheel; a hydraulic actuator adjusting a hydraulic pressure of the wheel cylinder; a control unit having a main unit that controls the hydraulic actuator on the basis of a brake operating amount by a driver and performs the computation of a target hydraulic pressure of the wheel cylinder, and a sub unit that drives the hydraulic actuator based on the target hydraulic pressure computed by the main unit.

According to a further aspect of the invention, a brake control apparatus comprises: a master cylinder; a wheel cylinder provided for a vehicle wheel; a hydraulic actuator provided separately from the master cylinder and adjusting a hydraulic pressure of the wheel cylinder; control means for controlling the hydraulic actuator on the basis of a brake operating amount by a driver; and the control means has: computation means for performing the computation of a target hydraulic pressure of the wheel cylinder; and driving means for driving the hydraulic actuator based on the target hydraulic pressure computed by the main unit.

According to a still further aspect of the invention, a method of brake control for a vehicle having a master cylinder, a wheel cylinder provided for a vehicle wheel, a hydraulic actuator provided separately from the master cylinder, and at least two units controlling the hydraulic actuator based on a brake operating amount by a driver, the method comprises: performing the computation of a target hydraulic pressure of the wheel cylinder and driving the hydraulic actuator by respectively different units.

The other objects and features of this invention will become understood from the following description with reference to the accompanying drawings.

### BRIEF DESCRIPTION OF THE DRAWINGS

FIG. 1 is a system block diagram of a brake control apparatus of the present invention.

FIG. 2 is a drawing of a hydraulic circuit of a first hydraulic pressure unit.

FIG. 3 is a drawing of a hydraulic circuit of a second hydraulic pressure unit.

FIG. 4 is a flow chart showing a process of a brake-by-wire control.

FIG. 5 is a flow chart showing a process of an open/close control of a stroke simulator selection valve.

FIG. 6 is an example in which an integrated controller is combined with a system of the brake control apparatus of the present invention.

FIG. 7 is an example in which an IN valve IN/V is set to normally open and a backflow toward a pump is prevented by a check valve.

### DETAILED DESCRIPTION OF THE INVENTION

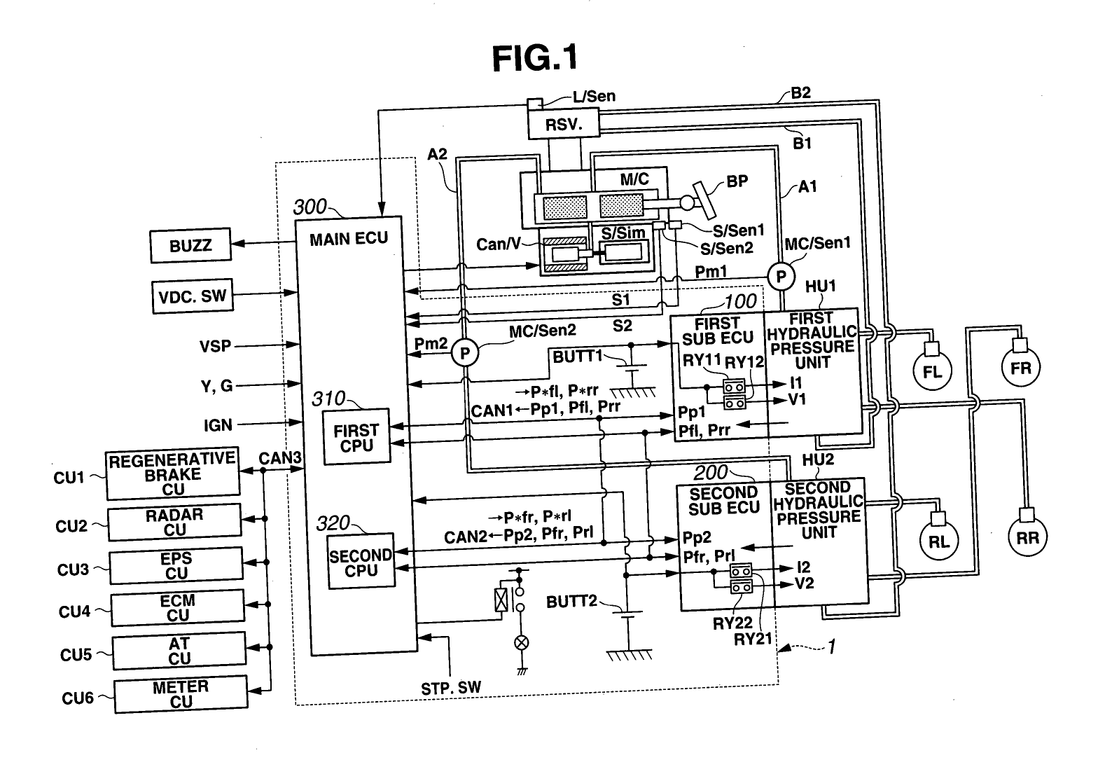

Embodiments of the present invention will be explained below with reference to the drawings. Firstly, a brake control apparatus of an embodiment 1 will be explained with reference to FIGS. 1 to 5.

[System Configuration]

FIG. 1 is a system block diagram of the brake control apparatus of the embodiment 1. The brake control apparatus is a four-wheel brake-by-wire system, and has two hydraulic pressure units; a first hydraulic pressure unit HU1 and a second hydraulic pressure unit HU2 (hydraulic pressure actuators, or simply, hydraulic actuators), each of which controls or adjusts hydraulic pressure independently of an operation of a brake pedal BP by a driver.

In a control unit 1 (control means), a main ECU 300 (a main unit) that performs the computation for or calculates target wheel cylinder pressures P*fl˜P*rr of the respective vehicle wheels FL˜RR (FL: left front wheel, FR: right front wheel, RL: left rear wheel, RR: right rear wheel), and first and second sub ECUs 100, 200 (first and second sub units) that respectively drive the first and second hydraulic pressure units HU1, HU2 (first and second hydraulic actuators), are provided.

These first and second hydraulic pressure units HU1, HU2 are driven by the first and second sub ECUs 100, 200 on the basis of a command from the main ECU 300. The brake pedal BP is provided with an operation reaction force (simply, reaction force) by a stroke simulator S/Sim connecting with a master cylinder M/C.

The first and second hydraulic pressure units HU1, HU2 are connected to the master cylinder M/C through oil passages A1, A2 respectively, and connected to a reservoir RSV through oil passages B1, B2 respectively. On the oil passages A1, A2, first and second M/C pressure sensors MC/Sen1, MC/Sen2 are respectively provided.

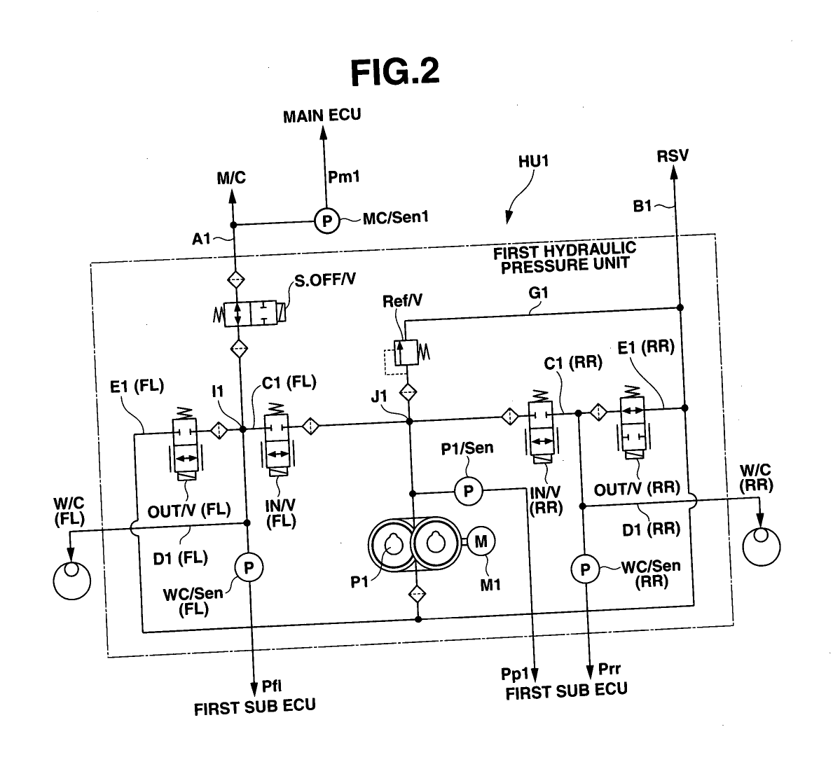

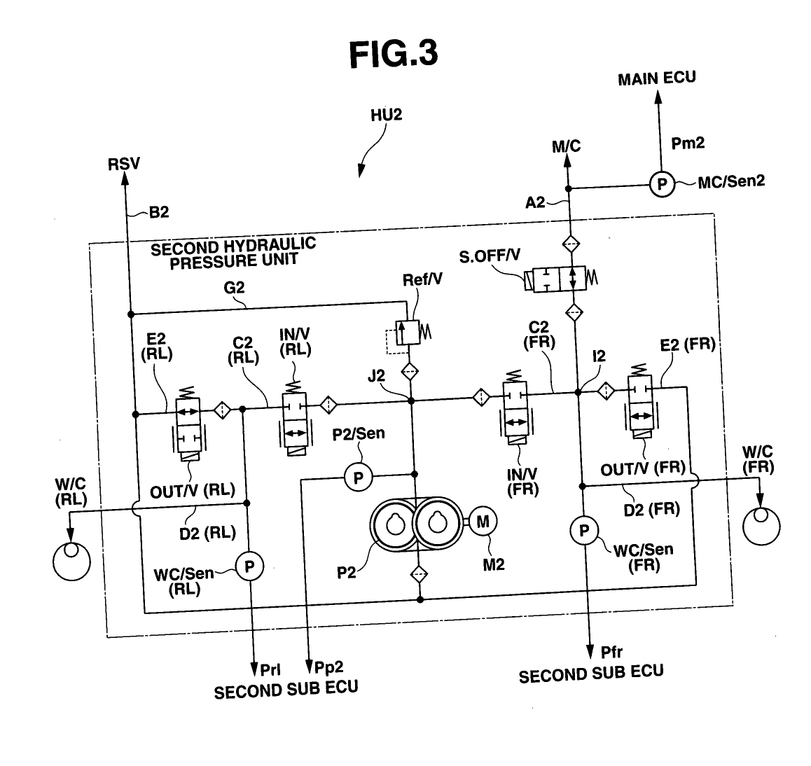

Further, the first and second hydraulic pressure units HU1, HU2 respectively have first and second pumps P1, P2, first and second motors M1, M2, and electromagnetic valves (see FIGS. 2 and 3). And as mentioned above, each of the first and second hydraulic pressure units HU1, HU2 is the hydraulic pressure actuator that generates or produces hydraulic pressure independently. The first hydraulic pressure unit HU1 controls hydraulic pressures of the wheels FL and RR. The second hydraulic pressure unit HU2 controls hydraulic pressures of the wheels FR and RL.

That is, by the first and second pumps P1, P2, each of which is a hydraulic pressure source (or hydraulic pressure generator), pressures of wheel cylinders W/C (FL˜RR) are directly increased. Here, since the wheel cylinder W/C is directly increased by these first and second pumps P1, P2 without using an accumulator, a gas leak from the accumulator to an inside of the oil passage, caused under fault conditions, does not arise. With respect to the hydraulic pressure control of the wheels FL˜RR, the first hydraulic pressure unit HU1 controls hydraulic pressures of the wheels FL, RR, and the second hydraulic pressure unit HU2 controls hydraulic pressures of the wheels FR, RL, with so-called X-piping arrangement or diagonal piping arrangement.

The first and second hydraulic pressure units HU1, HU2 are provided separately from each other. By separating the first and second hydraulic pressure units HU1, HU2, even if one hydraulic pressure unit fails due to leakage or damage, braking force can be secured by the other hydraulic pressure unit. However, the first and second hydraulic pressure units HU1, HU2 could be integrally formed with or connected to each other. In that case, two electric circuits can be integrated or combined into one electric circuit, and harness etc. can be shortened, and thereby simplifying its layout. The formation of the first and second hydraulic pressure units HU1, HU2 is not limited particularly, and can be changed in the above way.

Here, in order to make the system compact, it is preferable that the number of the hydraulic pressure source should be small. However, in a case of one hydraulic pressure source, if the hydraulic pressure source fails, this means that there is no backup. While, in a case of four hydraulic pressure sources provided for each wheel, although it is advantageous for the fail, the system becomes larger and also the control becomes complicated and difficult. For the brake-by-wire control, in particular, it is necessary that a redundant system should be provided. However, there is a possibility that the system will diverge due to an increase of the number of hydraulic pressure source.

Further, regarding the brake oil passage of vehicle, nowadays, the X-piping is generally used. In the X-piping, two wheels (diagonal wheels; FL-RR or FR-RL) that are diagonally arranged are hydraulically connected to each other through the oil passage. And each set of the diagonal wheels is pressurized by an independent hydraulic pressure source (tandem type master cylinder etc.). By this setting, even in a case where one set of the diagonal wheels fails, the other set of the diagonal wheels can generate or produce the braking force. Thus, at the time of the failure, it is possible to prevent the braking force from being biased or unbalanced. Accordingly, in general, the X-piping is used based on the premise that the number of the hydraulic pressure source is two.

Therefore, in the case of one hydraulic pressure source, configuration of the X-piping is impossible in the first place. On the other hand, in the case of three or four hydraulic pressure sources as well, since diagonal wheels cannot be hydraulically connected to each other by the same one hydraulic pressure source, there is no room for thinking of the X-piping.

Hence, in the embodiment of the present invention, in order to improve the resistance to failure without changing the configuration of X-piping, which is generally and widely used, the first and second hydraulic pressure units HU1, HU2 respectively having the first and second pumps P1, P2 as a hydraulic pressure source are provided, and double or dual hydraulic pressure sources is adopted.

Further, in the embodiment, during the brake application, since a front wheel load is large, significant braking force of rear wheels cannot be depended upon. In addition, in a case where the braking force of rear wheels is large, there is a risk that the vehicle will spin out. For this reason, regarding a braking force distribution of the front and rear wheels, in general, the distribution of the front wheel is greater than that of the rear wheel, and it is set, for example, front wheel is 2 and rear wheel is 1 (the braking force distribution of the front and rear wheels is 2:1).

Here, in the case as well where multiple-hydraulic pressure sources, namely, a plurality of the hydraulic pressure sources are provided to increase the resistance to failure, it is preferable that a plurality of the hydraulic pressure units, each of which has the same specifications, should be provided in view of cost. However, when considering the braking force distribution of the front and rear wheels, in a case where the hydraulic pressure sources are provided for each of the four wheels, two kinds of the hydraulic pressure units; one is for the front wheels, the other is for the rear wheels, have to be prepared. And further, these units' specifications have to be different from each other. However, in this case, it leads to increased cost. In the case of three hydraulic pressure sources as well, as long as the braking force distribution is different in the front wheels and rear wheels, the same problem arises.

Thus, in the embodiment of the present invention, the two hydraulic pressure units HU1, HU2 are set with the configuration of X-piping, and valve opening degree etc. are previously set in hydraulic circuits of the first and second hydraulic pressure units HU1, HU2 so that a ratio of the hydraulic pressures of the front wheels FL, FR and rear wheels RL, RR is 2:1. By providing the two hydraulic pressure units HU1, HU2 having the same specifications, the braking force distribution of the front and rear wheels can be 2:1 while achieving the low-cost dual hydraulic pressure sources.

[Main ECU]

The main ECU 300 is a higher CPU that calculates the target wheel cylinder pressures P*fl˜P*rr which each of the first and second hydraulic pressure units HU1, HU2 generates or produces. This main ECU 300 is connected to first and second power supplies BUTT1, BUTT2, and can operate as long as at least one of these power supplies BUTT1, BUTT2 functions normally. And then, the main ECU 300 operates or is activated by an ignition signal IGN from an ignition switch or an activating signal from other control units CU1 to CU6 which are connected to the main ECU 300 by means of CAN3 communication.

Brake pedal operating condition such as first and second stroke signals S1, 52 detected by first and second stroke sensor S/Sen1, S/Sen2, and first and second M/C pressures Pm1, Pm2 detected by the first and second M/C pressure sensors MC/Sen1, MC/Sen2 (these are operating amounts of the brake pedal by the driver) are input to the main ECU 300. Further, vehicle condition such as vehicle wheel speed “VSP”, yaw rate “Y”, and back-and-forth gravity “G” are also input to the main ECU 300. In addition, a detected value by a liquid level sensor L/Sen provided for the reservoir RSV is input to the main ECU 300, and the main ECU 300 judges whether or not execution of the brake-by-wire control by pump drive is possible. Furthermore, the main ECU 300 detects the operation of the brake pedal BP by a signal from a stop lamp switch STP. SW independently of the stroke signals S1, S2 and the M/C pressures Pm1, Pm2.

In this the main ECU 300, two CPUs; a first CPU 310 and a second CPU 320, which perform the computation, are provided. The first and second CPUs 310, 320 are respectively connected to the first and second sub ECUs 100, 200 by means of CAN communication lines CAN1, CAN2. And pump discharge pressures Pp1, Pp2 and actual wheel cylinder pressures Pfl˜Prr are input to the first and second CPUs 310, 320 through the first and second sub ECUs 100, 200. The CAN communication lines CAN1, CAN2 are connected to each other, and the each line is formed with double communication lines for backup.

The first and second CPUs 310, 320 calculate the target wheel cylinder pressures P*fl˜P*rr on the basis of the input signals (the operating condition and the vehicle condition); the stroke signals S1, S2, the M/C pressures Pm1, Pm2 and the actual wheel cylinder pressures Pfl˜Prr, and output the target wheel cylinder pressures P*fl˜P*rr to the first and second sub ECUs 100, 200 through the CAN communication lines CAN1, CAN2 (P*fl, P*rr are output to the first sub ECU 100 from the first CPU 310, P*fr, P*rl are output to the second sub ECU 200 from the second CPU 320).

Here, the first CPU 310 could calculate all of the target wheel cylinder pressures (P*fl, P*rr, and P*fr, P*rl) for the first and second hydraulic pressure units HU1, HU2, and then the second CPU 320 could act as a backup for the first CPU 310. This calculation and output are not limited particularly.

The main ECU 300 activates each of the first and second sub ECUs 100, 200 through the CAN communication lines CAN1, CAN2 by outputting signals which can separately activate the first and second sub ECUs 100, 200. With respect to the signal to activate the sub ECUs 100, 200, by one signal, the first and second sub ECUs 100, 200 could be activated at the same time. It is not to limited particularly. And the sub ECUs 100, 200 might be activated by the ignition switch IGN.

During vehicle movement or stability control such as ABS (control of increase/decrease of the braking force to avoid the wheels lock), VDC (control of increase/decrease of the braking force to avoid the skid of vehicle when the vehicle behavior is not controllable) and TCS (control to limit wheel spin of driving wheel), the main ECU 300 executes the control of the target wheel cylinder pressures P*fl˜P*rr while receiving and using the vehicle wheel speed “VSP”, yaw rate “Y” and back-and-forth gravity “G”. During the VDC, a warning is issued to the driver by a buzzer BUZZ. And ON/OFF of the VDC can be switched over or selected by driver's will by means of a VDC switch VDC. SW.

The main ECU 300 is connected to the other control units CU1 to CU6 through the CAN communication line CAN3, and executes a coordinated control. A regenerative brake control unit CU1 regenerates the braking force and transforms it to electric power. A radar control unit CU2 executes a vehicle distance control. An EPS control unit CU3 is a control unit for an automatic power steering system. An ECM control unit CU4 is a control unit for an engine. An AT control unit CU5 is a control unit for an automatic transmission. And a meter control unit CU6 controls each meter. The vehicle wheel speed “VSP” input to the main ECU 300 is output to the ECM control unit CU4, the AT control unit CU5 and the meter control unit CU6 through the CAN communication line CAN3.

As seen in FIG. 1, the power supply for each of the ECUs 100, 200 and 300 is the first and second power supplies BUTT1, BUTT2. The first power supply BUTT1 is connected to the main ECU 300 and the first sub ECU 100. While, the second power supply BUTT2 is connected to the main ECU 300 and the second sub ECU 200.

[Sub ECU]

The first and second sub ECUs 100, 200 are respectively integral with the first and second hydraulic pressure units HU1, HU2. However, they may be separately provided depending on a vehicle layout.

The target wheel cylinder pressures P*fl˜P*rr output from the main ECU 300, the pump discharge pressures Pp1, Pp2 of the first and second pumps P1, P2 and the each actual wheel cylinder pressures Pfl, Prr, and Pfr, Prl from the first and second hydraulic pressure units HU1, HU2 are input to the first and second sub ECUs 100, 200.

Then, the hydraulic pressure control is carried out based on the input pump discharge pressures Pp1, Pp2 and actual wheel cylinder pressures Pfl˜Prr so that the target wheel cylinder pressures P*fl˜P*rr are realized, by driving the first and second pumps P1, P2, the first and second motors M1, M2, and the electromagnetic valves, which are provided in the first and second hydraulic pressure units HU1, HU2. As mentioned above, the first and second sub ECUs 100, 200 may be respectively separated from the first and second hydraulic pressure units HU1, HU2.

These first and second sub ECUs 100, 200 are configured to execute a servo control that controls hydraulic pressures so that once the target wheel cylinder pressures P*fl˜P*rr are input, the hydraulic pressures converge to the last input values until new target values are input.

Further, by the first and second sub ECUs 100, 200, currents from the first and second power supplies BUTT1, BUTT2 are converted to valve driving currents I1, I2 and to motor driving voltages V1, V2, which are provided in the first and second hydraulic pressure units HU1, HU2, and are output to the first and second hydraulic pressure units HU1, HU2 through relays RY11, RY12, and RY21, RY22.

[Separation of Target Value Computation for Hydraulic Pressure Unit and Driving Control]

The main ECU 300 of the present invention executes only the target value computation (only calculates the target wheel cylinder pressures), and does not execute the driving control. If the main ECU 300 executes both of the target value computation and driving control, the main ECU 300 outputs a driving command to the first and second hydraulic pressure units HU1, HU2 on the basis of the coordinated control with other control units by means of CAN communication etc.

In this case, the target wheel cylinder pressures P*fl˜P*rr are output only after the CAN3 communication and the operation of the other control units CU1 to CU6 are completed. Because of this, if communication speed of the CAN3 communication and operation speed (computing speed) of the other control units are slow, there arises a problem that the brake control might also be delayed.

In addition, if the speed of communication line which connects to other controllers provided for the vehicle is increased, this leads to increased cost, and also there is a possibility that deterioration in the resistance to failure will occur due to noise.

Hence, in the embodiment of the present invention, function of the main ECU 300 for the brake control is only the computation of the target wheel cylinder pressures P*fl˜P*rr for the first and second hydraulic pressure units HU1, HU2. And as for the driving control of the first and second hydraulic pressure units HU1, HU2 of the hydraulic pressure actuators, it is carried out by the first and second sub ECUs 100, 200 executing the servo control.

In this way, the driving control of the first and second hydraulic pressure units HU1, HU2 is entirely carried out by the first and second sub ECUs 100, 200, and the coordinated control with the other control units CU1 to CU6 is carried out by the main ECU 300, and thereby executing the brake control without being affected by the communication speed and the operation speed of the other control units CU1 to CU6.

Accordingly, by executing the brake control independently of the other control, even in a case where a coordinated regenerative brake system that is necessary for hybrid vehicles or fuel-cell vehicles, and various units such as vehicle integrated controller or ITS, are provided or attached, it is possible to secure a response of the brake control while communicating with these units smoothly.

For the brake-by-wire control like the present invention, in particular, during a high-frequently-used normal brake operation, a precise brake control according to or corresponding to a depression amount (operating amount) of the brake pedal is required. For this reason, the separation of the target value computation control and the driving control for the hydraulic pressure unit becomes more effective.

[Master Cylinder and Stroke Simulator]

The stroke simulator S/Sim is provided in the master cylinder M/C, and produces the reaction force of the brake pedal BP. And in the master cylinder M/C, a stroke simulator selection valve (stroke simulator change-over valve or stroke simulator cancel valve) Can/V that selects communication/separation between the master cylinder M/C and stroke simulator S/Sim is provided.

This stroke simulator selection valve Can/V is opened or closed by the main ECU 300, and when the brake-by-wire control is completed or the first and second sub ECUs 100, 200 fail, it is possible to instantly switch over to manual brake. In the master cylinder M/C, the first and second stroke sensor S/Sen1, S/Sen2 are also provided, and then the stroke signals S1, S2 of the brake pedal BP are output to the main ECU 300.

[Hydraulic Pressure Unit]

FIGS. 2 and 3 are hydraulic circuits of the first and second hydraulic pressure units HU1, HU2. The first hydraulic pressure unit HU1 has a shutoff valve S.OFF/V, FL, RR wheels IN valves IN/V (FL, RR) of electromagnetic valves, FL, RR wheels OUT valves OUT/V (FL, RR) of electromagnetic valves, the pump P1, and the motor M1. Then, each valve opening degree etc. is previously set so that the ratio of the hydraulic pressures of the front wheels FL, FR and rear wheels RL, RR is substantially 2:1.

As can be seen in FIG. 2, a discharge side of the pump P1 is connected to the FL, RR wheel cylinders W/C (FL, RR) through oil passages C1 (FL, RR). While, a suction side of the pump P1 is connected to the reservoir RSV through the oil passage B1. The oil passages C1 (FL, RR) are connected to the oil passage B1 through oil passages E1 (FL, RR) respectively.

Further, a connection or junction point I1 between the oil passage C1 (FL) and the oil passage E1 (FL) is connected to the master cylinder M/C through the oil passage A1. A connection point J1 between the oil passages C1 (FL, RR) is connected to the oil passage B1 through an oil passage G1.

The shutoff valve S.OFF/V is a normally-open electromagnetic valve, and is provided on the oil passage A1. Then, connection/disconnection(or shutoff) between the master cylinder M/C and the connection point I1 is established by the shutoff valve S.OFF/V.

The FL, RR wheels IN valves IN/V (FL, RR) are normally-closed valves, and are provided on the oil passages C1 (FL, RR) respectively. The FL, RR wheels IN valves IN/V (FL, RR) control or adjust the discharge pressure of the pump P1 with proportional control, and the hydraulic pressures are supplied or provided to the FL, RR wheel cylinders W/C (FL, RR). Since the FL, RR wheels IN valves IN/V (FL, RR) are the normally-closed valves, a backflow toward the pump P1 of the M/C pressures Pm can be prevented at the time of the failure.

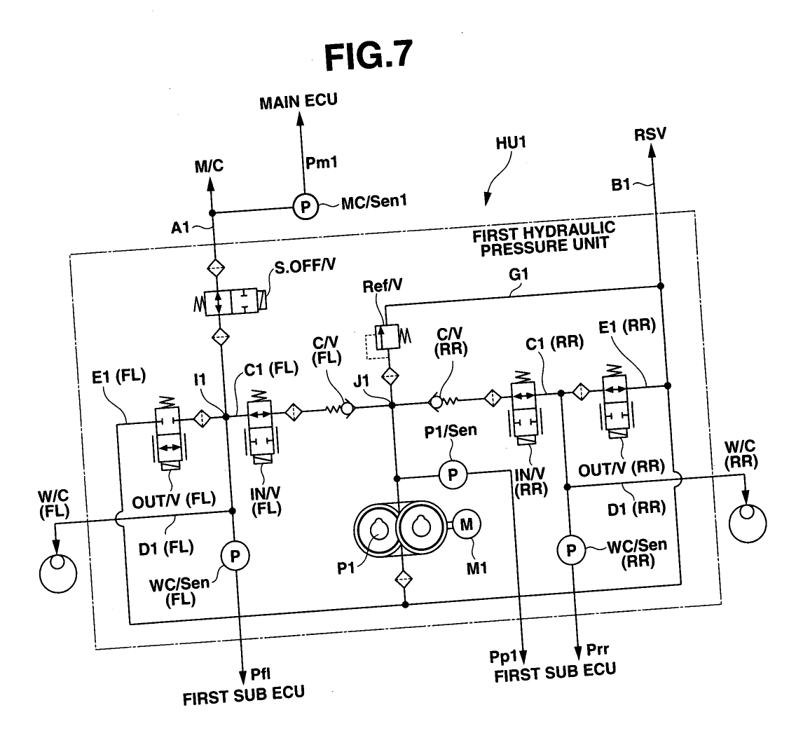

However, these FL, RR wheels IN valves IN/V (FL, RR) could be the normally-open valves. In that case, in order to prevent the backflow, check valves for preventing the backflow toward the pump P1 are provided on the oil passages C1 (FL, RR) (see FIG. 7). In this embodiment, since the FL, RR wheels IN valves IN/V (FL, RR) are the normally-closed valves, power consumption can be reduced.

As for the FL, RR wheels OUT valves OUT/V (FL, RR), these are provided on the oil passages E1 (FL, RR) respectively. The FL wheel OUT valve OUT/V (FL) is a normally-closed valve. While, the RR wheel OUT valve OUT/V (RR) is a normally-open valve. On the oil passage G1, a relief valve Ref/V is provided.

The first M/C pressure sensor MC/Sen1 is provided on the oil passage A1 between the first hydraulic pressure unit HU1 and the master cylinder M/C, and outputs the first M/C pressure Pm1 to the main ECU 300. Further, on the oil passages C1 (FL, RR) in the first hydraulic pressure unit HU1, FL, RR wheel cylinder pressure sensors WC/Sen (FL, RR) are provided, and output the detected value Pfl, Prr to the first sub ECU 100. And also, on the discharge side of the pump P1, a pump discharge pressure sensor P1/Sen is provided, and outputs the detected value Pp1 to the first sub ECU 100.

[Normal Brake]

(At the Pressurization)

In a case where a normal brake is applied by pressurization, the shutoff valve S.OFF/V is closed, and the FL, RR wheels IN valves IN/V (FL, RR) are opened, and further the FL, RR wheels OUT valves OUT/V (FL, RR) are closed, then the motor M1 is driven. By the motor M1, the pump P1 is driven, and the discharge pressures from the pump P1 are supplied to the oil passages C1 (FL, RR). Further, the discharge pressures are controlled or adjusted by the IN valves IN/V (FL, RR) (in other words, the IN valves IN/V (FL, RR) executes the hydraulic pressure control), and are introduced or supplied to the FL, RR wheel cylinders W/C (FL, RR), then the pressurization is achieved.

(At the Depressurization)

In a case of the depressurization of the normal brake, the IN valves IN/V (FL, RR) are closed, and the OUT valves OUT/V (FL, RR) are opened, then working fluid of the FL, RR wheel cylinders W/C (FL, RR) is discharged to the reservoir RSV, and thereby achieves the depressurization.

(Pressure Holding State)

In a case where the application of the normal brake is hold or maintained, the IN valves IN/V (FL, RR) and the OUT valves OUT/V (FL, RR) are all closed, and then the wheel cylinder pressures are maintained.

[Manual Brake]

When the manual brake is applied at such as system failure, the shutoff valve S.OFF/V is opened, and the IN valves IN/V (FL, RR) are closed. Therefore the M/C pressure Pm is not supplied to the RR wheel cylinder W/C (RR). On the other hand, as for the FL wheel OUT valve OUT/V (FL), since the FL wheel OUT valve OUT/V (FL) is the normally-closed valve, at the manual brake application, by closing the FL wheel OUT valve OUT/V (FL) (although the FL wheel OUT valve OUT/V (FL) is the normally-closed valve), the M/C pressure Pm is supplied to and acts on the FL wheel cylinder W/C (FL). Therefore, the M/C pressure Pm pressurized by way of the depression of the brake pedal BP by the driver is exerted on the FL wheel cylinder W/C (FL), and the manual brake can be secured.

Here, the manual brake (the M/C pressure Pm) could be exerted on the RR wheel cylinder W/C (RR) too. However, in the case where the M/C pressure Pm is exerted on both of the FL, RR wheel cylinders W/C (FL, RR) by the brake pedal depression of the driver, a load of depression, which is put on the driver, is large, and this is not practical. Thus, in the embodiment of the present invention, in the first hydraulic pressure unit HU1, the manual brake (the M/C pressure Pm) is exerted on only the FL wheel of which braking force is larger.

Further, as mentioned above, the RR wheel OUT valve OUT/V (RR) is the normally-open valve, and upon the occurrence of the system failure, a residual or remaining pressure of the RR wheel cylinder W/C (RR) is immediately discharged, and lock of the RR wheel can be avoided.

Meanwhile, as for the second hydraulic pressure unit HU2 also, as can be seen in FIG. 3, configuration of the hydraulic circuit and control are the same as the first hydraulic pressure unit HU1. With respect to the valves, in the same manner as the first hydraulic pressure unit HU1, a FR wheel OUT valve OUT/V (FR) is a normally-closed valve. While, a RL wheel OUT valve OUT/V (RL) is a normally-open valve. And the manual brake (the M/C pressure Pm) is exerted on only the FR wheel.

[Brake-by-Wire Control Process]

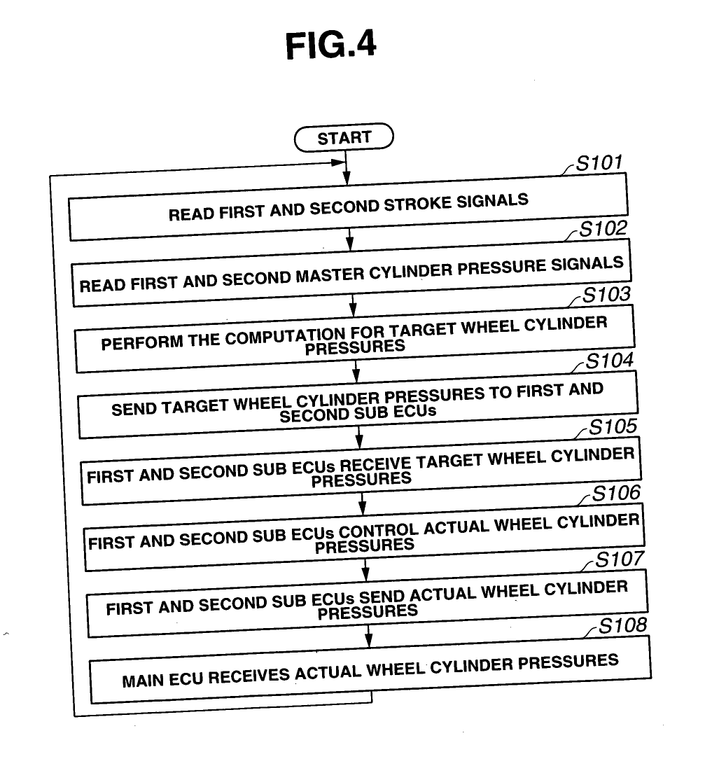

FIG. 4 is a flow chart showing the process of the brake-by-wire control executed by the main ECU 300 and the first and second sub ECUs 100, 200. In the following, each step of the flow chart will be explained.

At step S101, the first and second stroke signals S1, S2 are read, and the routine proceeds to step S102.

At step S102, the first and second M/C pressures Pm1, Pm2 are read, and the routine proceeds to step S103.

At step S103, the target wheel cylinder pressures P*fl˜P*rr for the first and second hydraulic pressure units HU1, HU2 are calculated or computed by the first and second CPUs 310, 320 in the main ECU 300, and the routine proceeds to step S104.

At step S104, the target wheel cylinder pressures P*fl˜P*rr are sent from the main ECU 300 to the first and second sub ECUs 100, 200, and the routine proceeds to step S105.

At step S105, the first and second sub ECUs 100, 200 receive the target wheel cylinder pressures P*fl˜P*rr, and the routine proceeds to step S106.

At step S106, the first and second sub ECUs 100, 200 drive the first and second hydraulic pressure units HU1, HU2, and control or adjust the actual wheel cylinder pressures Pfl˜Prr, and the routine proceeds to step S107.

At step S107, the first and second sub ECUs 100, 200 send the actual wheel cylinder pressures Pfl˜Prr to the main ECU 300, and the routine proceeds to step S108.

At step S108, the main ECU 300 receives the each actual wheel cylinder pressures Pfl˜Pr, and the routine returns to step S101.

[Stroke Simulator Selection Valve Open/Close Control]

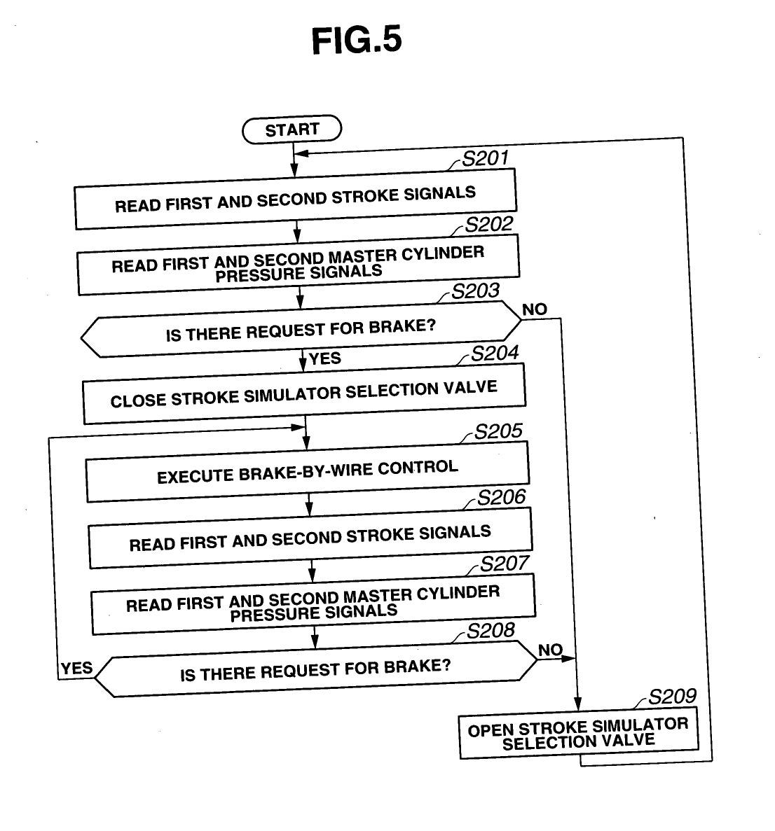

FIG. 5 is a flow chart showing a process of an open/close control of the stroke simulator selection valve Can/V, which is executed by the main ECU 300.

At step S201, the first and second stroke signals S1, S2 are read, and the routine proceeds to step S201.

At step S202, the first and second M/C pressures Pm1, Pm2 are read, and the routine proceeds to step S203.

At step S203, a check is made to determine whether or not there is a request for brake by the driver based on the read stroke signals S1, S2 and M/C pressures Pm1, Pm2. If YES, the routine proceeds to step S204. While, if NO, the routine proceeds to step S209.

At step S204, the stroke simulator selection valve Can/V is closed, and the routine proceeds to step S205.

At step S205, the brake-by-wire control shown in FIG. 4 is executed, and the routine proceeds to step S206.

At step S206, the first and second stroke signals S1, S2 are read, and the routine proceeds to step S207.

At step S207, the first and second M/C pressures Pm1, Pm2 are read, and the routine proceeds to step S208.

At step S208, a check is made to determine whether or not there is a request for brake by the driver based on the read stroke signals S1, S2 and M/C pressures Pm1, Pm2. If YES, the routine proceeds to step S205. While, if NO, the routine proceeds to step S209.

At step S209, the stroke simulator selection valve Can/V is opened, and the routine returns to step S201.

[Effects of the Embodiment of the Present Invention]

(1) In the embodiment of the present invention, the main ECU 300 performing the computation of the target hydraulic pressure P* of the wheel cylinder W/C, and the first and second sub ECUs 100, 200 driving the first and second hydraulic pressure units HU1, HU2 on the basis of the target hydraulic pressure P* calculated by the main ECU 300, are provided. Thus, the driving control of the first and second hydraulic pressure units HU1, HU2 is entirely carried out by the first and second sub ECUs 100, 200, and the computation of the target hydraulic pressure P* and the coordinated control with the other control units CU1 to CU6 are carried out by the main ECU 300. It is therefore possible that the computation of the target hydraulic pressure P* and the driving control of the hydraulic pressure units HU1, HU2 are separately executed by the different control units without being affected by the communication speed and the operation speed of the other control units CU1 to CU6. And further, in the case where the various units are attached and the communication speed and the operation speed of the other control units are slow, the response of the brake control can be secured while communicating with these units smoothly.

(2) The first and second hydraulic pressure units HU1, HU2 are provided as hydraulic pressure actuators, and the first hydraulic pressure unit HU1 controls hydraulic pressures of the wheels FL and RR, while the second hydraulic pressure unit HU2 controls hydraulic pressures of the wheels FR and RL, with the configuration of X-piping. By the configuration of X-piping, the valve opening degree etc. can be set in hydraulic circuits of the first and second hydraulic pressure units HU1, HU2 so that the ratio of the hydraulic pressures of the front wheels FL, FR and rear wheels RL, RR is 2:1. And by providing the two hydraulic pressure units HU1, HU2 having the same specifications, the braking force distribution of the front and rear wheels can be 2:1 while achieving the dual hydraulic pressure sources.

(3) The first and second sub ECUs 100, 200 are provided as sub units, and the first sub ECU 100 drives the first hydraulic pressure unit HU1, while the second sub ECU 200 drives the second hydraulic pressure unit HU2. Thus, even if one of these first and second hydraulic pressure units HU1, HU2 fails, the braking force can be secured by the other hydraulic pressure unit.

(4) The first and second sub ECUs 100, 200 are supplied with power from the first and second power supplies BUTT1, BUTT2 respectively, and the main ECU 300 is supplied with power from both these power supplies BUTT1, BUTT2. And then, the main ECU 300 can operate by only one power supply as well. Thus, even if one of these power supplies BUTT1, BUTT2 fails, by driving any one of the hydraulic pressure units HU1, HU2, the braking force can be secured.

(5) The main ECU 300 and the first and second sub ECUs 100, 200 are communicated with each other by the double (dual) or more communication lines of the CAN communication lines CAN1, CAN2. Thus, even if one of the CAN communication lines fails, the other CAN communication lines works as backup.

(6) The stroke simulator S/Sim that is connected with the master cylinder M/C and provides the operation reaction force to the brake pedal BP is provided. And the main ECU 300 selects the communication/separation (shutoff) between the stroke simulator S/Sim and master cylinder M/C (or switches over between the communication/separation (shutoff) of the stroke simulator S/Sim and master cylinder M/C). Thus, when the brake-by-wire control is completed or the first and second sub ECUs 100, 200 fail, it is possible to instantly switch over to the manual brake.

(7) The stroke simulator selection valve Can/V switching over between communication/separation (shutoff) of the stroke simulator S/Sim and master cylinder M/C) is further provided. This stroke simulator selection valve Can/V is controlled by the main ECU 300 and then the valve Can/V opens or closes. Thus, it is possible to instantly switch over to the manual brake by the control of the main ECU 300.

### OTHER EMBODIMENTS

The best embodiment has been explained above on the basis of the embodiment 1. However, the configuration of the present invention is not limited to the embodiment 1. Even if the configuration is redesigned or modified within the substance of the present invention, it resides in the present invention.

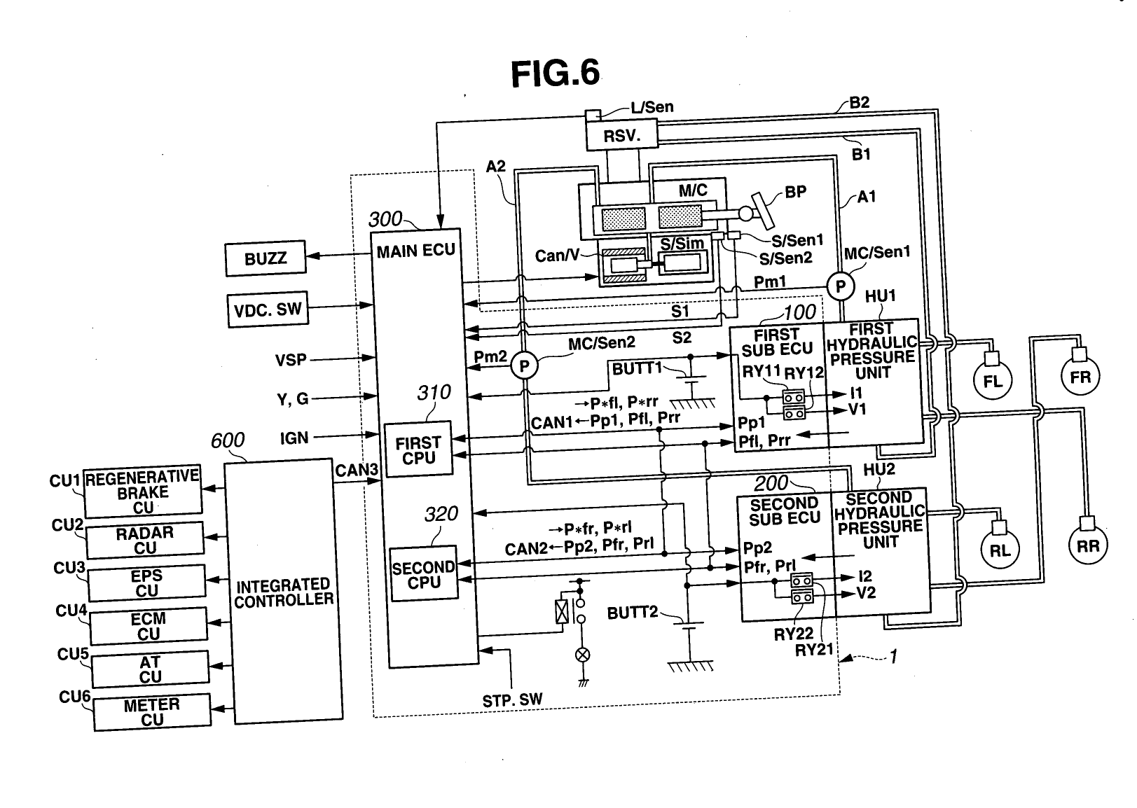

For example, as shown in FIG. 6, an integrated controller 600 that executes various controls such as the control of the coordinated regenerative brake system or the ITS is provided. In the case as well where the integrated controller 600 is combined with the brake control apparatus, since the brake control is carried out independently of the other control systems, it is possible to attach the integrated controller 600 to, or to combine the integrated controller 600 with the brake control apparatus easily without particularly changing the brake-control system.

In the embodiment 1, the IN valves IN/V (FL˜RR) are the normally-closed valves. However, as previously mentioned and as seen in FIG. 7, the IN valves IN/V (FL˜RR) could be the normally-open valves, and in this case, in order to prevent the backflow, the check valves C/V (FL, RR) for preventing the backflow toward the pump P1 are provided on the oil passages C1 (FL, RR). Since the backflow can be prevented by the check valves C/V (FL, RR) not by the IN valves IN/V (FL, RR), power consumption can be reduced.

This application is based on a prior Japanese Patent Application No. 2006-000304 filed on Jan. 5, 2006. The entire contents of this Japanese Patent Application No. 2006-000304 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
a master cylinder;
a wheel cylinder provided for a vehicle wheel;
a hydraulic actuator provided separately from the master cylinder and adjusting a hydraulic pressure of the wheel cylinder;
a control unit controlling the hydraulic actuator on the basis of a brake operating amount by a driver; and
the control unit having a main unit that performs the computation of a target hydraulic pressure of the wheel cylinder and a sub unit that drives the hydraulic actuator based on the target hydraulic pressure computed by the main unit.

2. The brake control apparatus as claimed in claim 1, wherein:
the hydraulic actuator comprises first and second hydraulic actuators,
the first hydraulic actuator adjusts the hydraulic pressures of the wheel cylinder of left front and right rear wheels, and
the second hydraulic actuator adjusts the hydraulic pressures of the wheel cylinder of right front and left rear wheels.

3. The brake control apparatus as claimed in claim 2, wherein:
the sub unit comprises first and second sub units,
the first sub unit drives the first hydraulic actuator, and
the second sub unit drives the second hydraulic actuator.

4. The brake control apparatus as claimed in claim 3, wherein:
the first and second sub units are supplied with power from first and second power supplies respectively, and
the main unit is supplied with power from both of the first and second power supplies, and the main unit operates by any one of the first and second power supplies.

5. The brake control apparatus as claimed in claim 1, wherein:
the main unit and the sub unit are communicated with each other by means of double or more communication lines.

6. The brake control apparatus as claimed in claim 3, further comprising:
a stroke simulator that is connected with the master cylinder and provides an operation reaction force to a brake pedal,
wherein:
the main unit switches over between communication/separation of the stroke simulator and the master cylinder.

7. The brake control apparatus as claimed in claim 6, further comprising:
a selection valve that switches over between communication/separation of the stroke simulator and the master cylinder,
wherein:
open/close of the selection valve is controlled by the main unit.

8. The brake control apparatus as claimed in claim 1, wherein:
brake pedal operating condition and vehicle condition are input to the main unit, and the main unit performs the computation of the target hydraulic pressure according to values of the input conditions.

9. A brake control apparatus comprising:
a wheel cylinder provided for a vehicle wheel;
a hydraulic actuator adjusting a hydraulic pressure of the wheel cylinder;
a control unit having a main unit that controls the hydraulic actuator on the basis of a brake operating amount by a driver and performs the computation of a target hydraulic pressure of the wheel cylinder, and a sub unit that drives the hydraulic actuator based on the target hydraulic pressure computed by the main unit.

10. The brake control apparatus as claimed in claim 9, wherein:
the hydraulic actuator comprises first and second hydraulic actuators,
the first hydraulic actuator adjusts the hydraulic pressures of the wheel cylinder of left front and right rear wheels, and
the second hydraulic actuator adjusts the hydraulic pressures of the wheel cylinder of right front and left rear wheels.

11. The brake control apparatus as claimed in claim 10, wherein:
the sub unit comprises first and second sub units,
the first sub unit drives the first hydraulic actuator, and
the second sub unit drives the second hydraulic actuator.

12. The brake control apparatus as claimed in claim 11, wherein:
the first and second sub units are supplied with power from first and second power supplies respectively, and
the main unit is supplied with power from both of the first and second power supplies, and the main unit operates by any one of the first and second power supplies.

13. The brake control apparatus as claimed in claim 9, wherein:
the main unit and the sub unit are communicated with each other by means of double or more communication lines.

14. The brake control apparatus as claimed in claim 11, wherein:
the hydraulic actuator is provided separately from a master cylinder,
and wherein:
the brake control apparatus further comprises a stroke simulator that is connected with the master cylinder and provides an operation reaction force to a brake pedal, and
the main unit switches over between communication/separation of the stroke simulator and the master cylinder.

15. The brake control apparatus as claimed in claim 14, further comprising:
a selection valve that switches over between communication/separation of the stroke simulator and the master cylinder,
wherein:
open/close of the selection valve is controlled by the main unit.

16. The brake control apparatus as claimed in claim 9, wherein:
brake pedal operating condition and vehicle condition are input to the main unit, and the main unit performs the computation of the target hydraulic pressure according to values of the input conditions.

17. A brake control apparatus comprising:
a master cylinder;
a wheel cylinder provided for a vehicle wheel;
a hydraulic actuator provided separately from the master cylinder and adjusting a hydraulic pressure of the wheel cylinder;
control means for controlling the hydraulic actuator on the basis of a brake operating amount by a driver; and
the control means having:
computation means for performing the computation of a target hydraulic pressure of the wheel cylinder; and
driving means for driving the hydraulic actuator based on the target hydraulic pressure computed by the main unit.

18. A method of brake control for a vehicle having a master cylinder, a wheel cylinder provided for a vehicle wheel, a hydraulic actuator provided separately from the master cylinder, and at least two units controlling the hydraulic actuator based on a brake operating amount by a driver, the method comprising:
performing the computation of a target hydraulic pressure of the wheel cylinder and driving the hydraulic actuator by respectively different units.
